(19) United States
(12) Patent Application Publication
(10) Pub. No.: US 2024/0031107 A1
(43) Pub. Date: Jan. 25, 2024

(54) CONTROL CHANNEL MONITORING ENHANCEMENTS

(71) Applicant: Fraunhofer-Gesellschaft zur Förderung der angewandten Forschung e.V., München (DE)

(72) Inventors: Baris GÖKTEPE, Berlin (DE); Sarun SELVANESAN, Berlin (DE); Thomas FEHRENBACH, Berlin (DE); Thomas WIRTH, Berlin (DE); Thomas SCHIERL, Berlin (DE); Cornelius HELLGE, Berlin (DE)

(21) Appl. No.: 18/477,595

(22) Filed: Sep. 29, 2023

Related U.S. Application Data
(63) Continuation of application No. PCT/EP2022/058662, filed on Mar. 31, 2022.

(30) Foreign Application Priority Data
Apr. 1, 2021 (EP) 21166597.1

(51) Int. Cl. H04L 5/00; H04W 72/25; H04W 72/232

(52) U.S. Cl. CPC H04L 5/0053; H04W 72/25; H04W 72/232

(57) ABSTRACT

A user device, UE, for a wireless communication system, is described, which skips a certain number of control channel monitoring occasions, MOs, like physical downlink control channel, PDCCH, MOs, or a physical sidelink control channel, PSCCH, MOs, in accordance with a certain control channel MO skipping pattern.

### CROSS-REFERENCE TO RELATED APPLICATIONS

This application is a continuation of copending International Application No. PCT/EP2022/058662, filed Mar. 31, 2022, which is incorporated herein by reference in its entirety, and additionally claims priority from European Application No. 21166597.1, filed Apr. 1, 2021, which is also incorporated herein by reference in its entirety.

The present application relates to the field of wireless communication systems or networks, more specifically to a control channel monitoring enhancements.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 1121. The device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi communication system or a 4G or 5G mobile communication system. Further, some or all of the respective base station gNB₁ to gNB₅ may be connected, e.g. via the S1 or X2 interface or the XN interface in NR, with each other via respective backhaul links 116, to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also have a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g. Discrete Fourier Transform-spread-OFDM, DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels. When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

In a wireless communication system or network, like the one described above with reference to FIG. 1, the respective user devices, UEs, monitor the control channel in every subframe in order to be able to receive from the network and from another UE, respectively.

It is noted that the information in the above section is only for enhancing the understanding of the background of the invention and, therefore, it may contain information that does not form conventional technology that is already known to a person of ordinary skill in the art.

### SUMMARY

An embodiment may have a user device, UE, for a wireless communication system, wherein the UE is to skip a certain number of control channel monitoring occasions, MOs, like physical downlink control channel, PDCCH, MOs, or a physical sidelink control channel, PSCCH, MOs, wherein, among the channel monitoring occasions to be skipped, the UE is to determine one or more exceptional control channel MOs which are not to be skipped, and the UE is not to skip the one or more exceptional control channel MOs, wherein the UE is configured or preconfigured, e.g., by a Radio Resource Control, RRC, signaling, with one or more rules for determining a MO as an exceptional MO, and/or wherein the one or more rules for determining a MO as an exceptional MO are fixed in a specification, and wherein the one or more rules may include one or more of the following: the MO is associated with an ongoing transmission or retransmission, the MO is associated with ongoing periodic transmissions, e.g., SPS, the MO is associated with a previous transmission of a packet for which a reply is expected, the MO includes a pre-emption signaling, e.g., when a plurality of transmissions are planned, the MO includes one or more CSI reports, e.g., for the SL, the MO uses certain resources for a high priority or emergency signaling, the MO is associated with pre-reserved transmissions, the MO contains a common search space.

According to another embodiment, a wireless communication system may have: one or more inventive user devices, UEs, and a base station for serving the one or more, UEs, wherein the base station is to support a communication of the UEs over the Uu interface and over a sidelink, SL, and wherein the BS is to configure or preconfigure a UE to skip only SL-related control channel MOs, or only Uu-related control channel MOs, or both SL-related control channel MOs and Uu-related control channel MOs.

According to another embodiment, a method for operating a user device, UE, for a wireless communication system, wherein the UE is to skip a certain number of control channel monitoring occasions, MOs, like physical downlink control channel, PDCCH, MOs, or a physical sidelink control channel, PSCCH, MOs, may have the steps of: determining which are not to be skipped one or more exceptional control channel MOs which are not to be skipped, and not skipping the one or more exceptional control channel MOs, wherein the UE is configured or preconfigured, e.g., by a Radio Resource Control, RRC, signaling, with one or more rules for determining a MO as an exceptional MO, and/or wherein the one or more rules for determining a MO as an exceptional MO are fixed in a specification, and wherein the one or more rules may include one or more of the following: the MO is associated with an ongoing transmission or retransmission, the MO is associated with ongoing periodic transmissions, e.g., SPS, the MO is associated with a previous transmission of a packet for which a reply is expected, the MO includes a pre-emption signaling, e.g., when a plurality of transmissions are planned, the MO includes one or more CSI reports, e.g., for the SL, the MO uses certain resources for a high priority or emergency signaling, the MO is associated with pre-reserved transmissions, the MO contains a common search space.

### BRIEF DESCRIPTION OF THE DRAWINGS

Embodiments of the present invention will be detailed subsequently referring to the appended drawings, in which:

FIGS. 1(a)-1(b) show a schematic representation of an example of a wireless communication system;

FIG. 2 schematically illustrates a conventional PDCCH skipping approach;

FIG. 3(a) illustrates a conventional PDCCH skipping approach implemented by skipping a PDCCH region of a frame;

FIG. 3(b) illustrates a conventional PDCCH skipping approach implemented by causing a UE to switch to an empty search space group;

FIG. 4 is a schematic representation of a wireless communication system including a transmitter, like a base station, and one or more receivers, like user devices or UEs, capable of operating in accordance with embodiments of the present invention;

FIG. 5 illustrates an embodiment of a control channel MO skipping pattern in accordance with the present invention;

FIG. 6 illustrates a further embodiment of a control channel MO skipping pattern in accordance with the present invention; and

FIG. 7 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

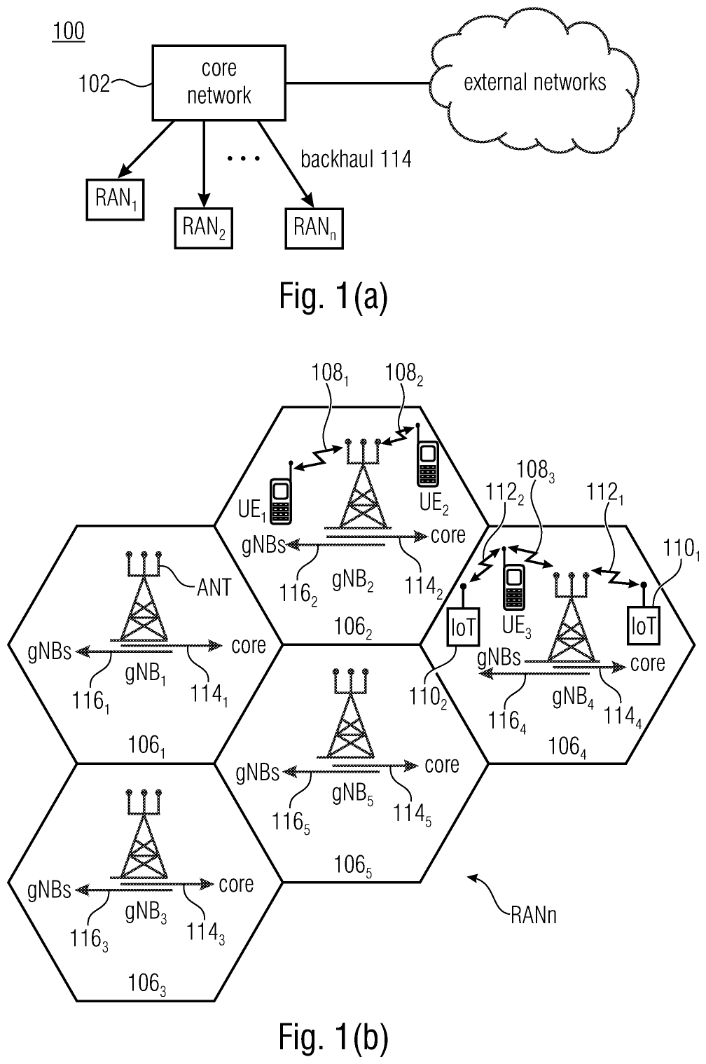

In the wireless communication system or network, like the one described above with reference to FIG. 1, the respective user devices, UEs, may communicate with an access point of the RAN, like a base station, or they may communicate with other UEs over a sidelink. The sidelink communication may be, for example, a vehicle-to-vehicle communication, V2V, a vehicle-to-anything communication, V2X, or any device-to-device communication, D2D. However, in a NR-Uu operation or in a sidelink operation, like a PC5 operation, the user device is awake at all times and monitors the control channel in every subframe in order to be able to receive from the network and from another UE, respectively. This increases the power consumption at the UE, since the UE is on, even when there is no data to be transmitted or received.

For stationary or vehicular use cases, like NR V2X, power saving may not be a concern since the UE may be connected to a power source, e.g., a power grid in case of a stationary or fixed UE, or an onboard battery of the vehicle in case of a vehicular UE, V-UEs. However, for other UEs with a limited or finite power supply, like regular user devices including a battery that needs to be recharged regularly, power saving is of concern. Such UEs may include so-called vulnerable road users, VUEs, like a pedestrian UE, P-UE, or first responder devices for public safety use cases, or IoT devices, like general IoT UEs or industrial IoT UEs. For these types of UEs, since they are not connected to a constant power supply but rely on their battery, power saving is important.

In accordance with conventional approaches, power saving when communicating in a wireless communication network, like the one described above with reference to FIG. 1, may be improved by applying the so-called control channel skipping, like the physical download control channel, PDCCH, skipping, or the physical sidelink control channel, PSCCH, skipping. When considering the communication of a UE with the RAN of the wireless communication network, the UE may skip one or more PDCCH monitoring occasions, MOs. For example, the base station may send a downlink control information, DCI, to indicate to the UE to perform the PDCCH skipping, for example in case the base station has no data to be transmitted to the UE. Responsive to the indication, the UE stops monitoring the PDCCH, thereby saving power.

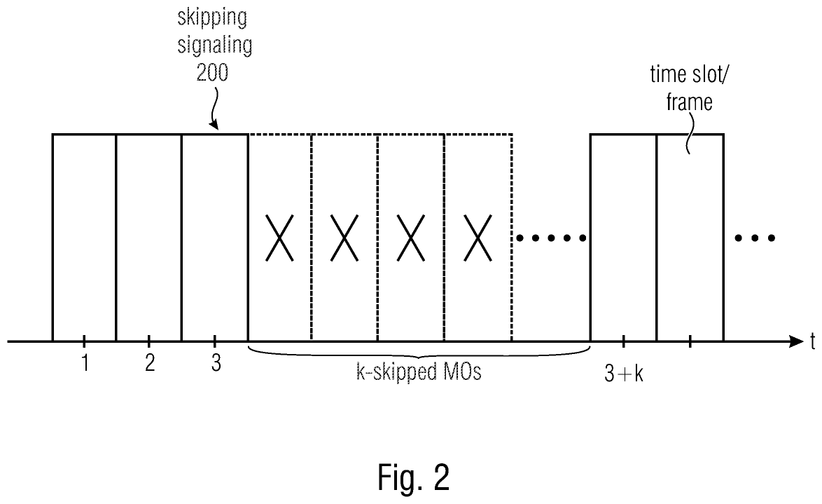

FIG. 2 schematically illustrates a conventional PDCCH skipping approach. A plurality of time slots is schematically indicated and it is assumed that a UE, which is communicating with the RAN or with another UE over the sidelink, monitors in each of the time slots the PDCCH or PSCCH. In time slots 1, 2 and 3 it is assumed that the UE carries out the conventional monitoring of the PDCCH monitoring occasions. At time slot 3, the UE receives the skipping indication 200, e.g., a DCI-based or SCI-based signaling to skip the next k PDCCH MOs. Following the indication 200, the UE stops monitoring the control channel in the next k time slots and resumes the monitoring at the time slot 3+k. The skipping indication 200, as mentioned above, may be a DCI-based signaling. The skipped MOs are schematically illustrated as crossed-out MOs.

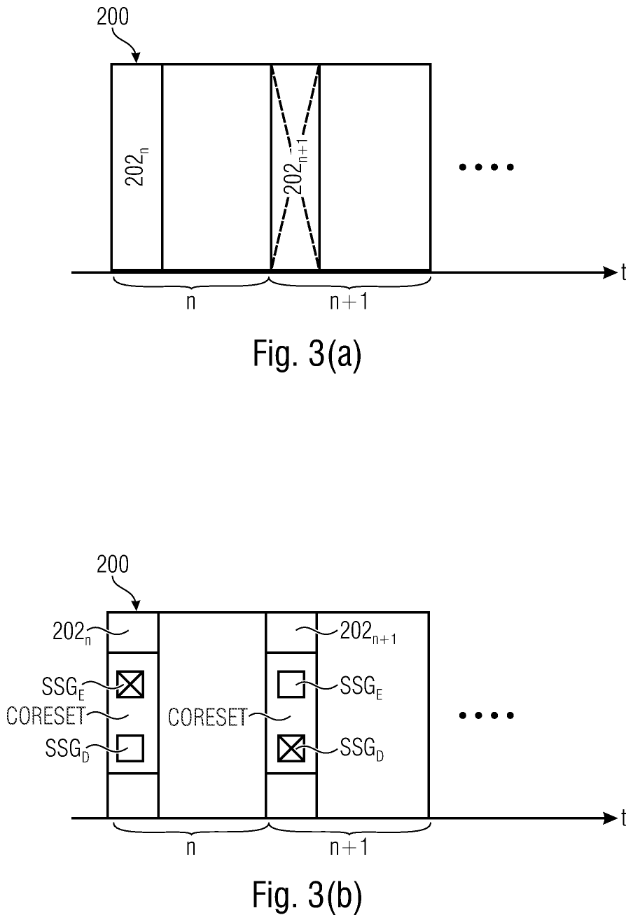

FIG. 3 illustrates the PDCCH skipping in accordance with the above-described examples. In FIG. 3(a), a subframe or time slot is illustrated having, for example, at the beginning, the PDCCH region, including, for example, in case of NR, one or more CORESETs with respective search spaces which define or are part of the PDCCH monitoring occasions in which the UE is to monitor for control messages directed to the UE. When receiving, for example, a DCI-based skipping signaling, the UE may simply stop monitoring the PDCCH region in the upcoming subframes or time slots. FIG. 3(a) illustrates the time slots n and n+1 including the control regions 202ₙ and 202ₙ₊₁. Responsive to the skipping indication 200 in frame or slot n, a UE, responsive to the signaling 200 may skip monitoring the entire control region starting from the following time slot n+1 for a certain number of time slots that may be indicated by the signaling, for example, as mentioned above, k PDCCH monitoring occasions. The skipped MO is schematically by the crossed-out MO in slot n+1.

In accordance with other examples, the skipping may also be achieved by configuring an empty search space group, SSG, and signaling the UE, for example, by means of the skipping indication 200, to switch to the empty SSG. After a certain time, like the passing of an inactivity timer, the UE may switch back to the default or previous SSG. FIG. 3(b) illustrates the switching of the UE to an empty SSG. FIG. 3(b) illustrates two time slots or subframes n and n+1 each configured within the control region with a control resource set, CORESET, in which at least one search space group, also referred to as the default search space group SSG_{D} is defined which the UE monitors for control messages dedicated for the UE. In addition, an empty search space group SSG_{E} is configured. Initially, when not having received a skipping signaling, the UE monitors the default search space group SSG_{D}. Responsive to a skipping indication 200 received in slot n, the UE switches from the default search space group SSG_{D} to the empty search space group SSG_{E}. In FIG. 3(b), the non-used search space group is schematically illustrated as the crossed-out box labeled SSG_{D} or SSG_{E}. A SSG contains search spaces so that a SSG switch causes the UE to apply different search spaces which are associated with the currently active SSG. An empty SSG does not contain any search space, so the UE does not monitor any PDCCH when an empty SSG is active. The UE uses the empty search space group, for example, for a certain number of frames or time slots which may be indicated in the signaling 200 and then switches back to the default search space group. In accordance with other examples, responsive to the signaling 200 a timer may be started so that the UE switches back to the default search space group once the timer has lapsed. For example, an inactivity timer, similar to the one used when operating in a discontinuous reception, DRX, mode may be employed.

The above-described conventional examples for causing a UE to skip PDCCH MOs may be implemented for any of the UEs described above. The process may also be implemented for UEs already operating in the DRX mode so that, for example, during the ON duration of the DRX cycle the UE may be signaled to skip a certain number of upcoming PDCCH MOs or PSSCH MOs during the ON duration of the DRX cycle.

While the approach described above with reference to FIG. 2 and FIG. 3 may allow for further power savings at the UE, the skipping of a certain number of MOs may create a sub-optimal or undesired behavior of the UE in certain situations. For example, one or more of the skipped control channel MOs may include certain information that is not be missed by the UE to avoid an undesired behavior during the further operation of the UE once it restarts with the monitoring of the control messages in the control channel. For example, the UE may miss a Slot Format Indicator, SFI, which is transmitted during the skipped PDCCH MOs and, hence, may not be able to use certain slots with flexible symbols which may be relabeled to UL or DL in the missed SFI. In another example, the UE may perform a k-repetition PUSCH transmission where it skips PDCCH MOs in which it might receive a Downlink Feedback Indicator, DFI. Hence, it may miss an ACK in the DFI for the k-repetition transmission and performs unnecessary retransmissions causing wasted power consumption.

Further, in accordance with the conventional approaches for saving power by skipping control channel MOs, the UE applies the skipping responsive to an indication or a signaling that is received, e.g., from a base station. However, there may be situations in which the UE is to save power but may not receive any control signaling from the base station, e.g., a UE communicating over the sidelink or using an unlicensed band. Also, when considering a communication over the Uu interface, a base station may not be aware of a specific situation at a UE needing the UE, like an IoT device, to save power, like a very low battery status.

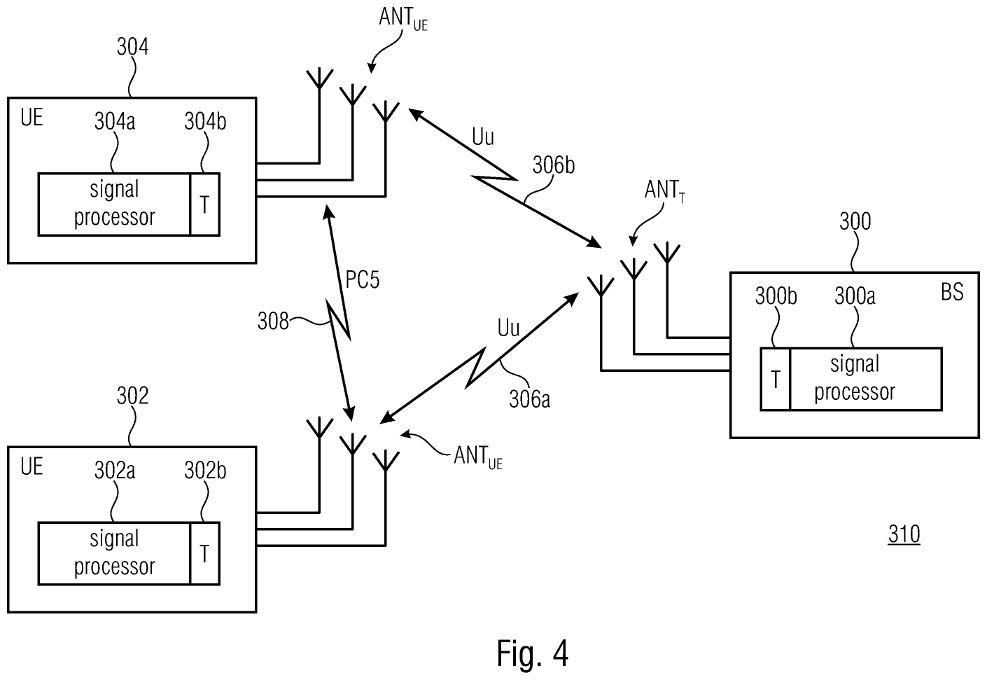

The present invention addresses the above-described drawbacks and provides enhancements and improvements for the control channel monitoring. Embodiments of the inventive approach describe different techniques for optimizing or improving the above-described conventional control channels skipping feature. Embodiments of the present invention may be implemented in a wireless communication system as depicted in FIG. 1, FIG. 2 or FIG. 3 including base stations and users, like mobile terminals or IoT devices. FIG. 4 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 4, the one or more UEs 302, 304 of FIG. 4, and the base station 300 of FIG. 4 may operate in accordance with the inventive teachings described herein.

### Apparatus

### Skipping Patterns

The present invention provides a user device, UE, for a wireless communication system, wherein the UE is to skip a certain number of control channel monitoring occasions, MOs, like physical downlink control channel, PDCCH, MOs, or a physical sidelink control channel, PSCCH, MOs, in accordance with a certain control channel MO skipping pattern.

In accordance with embodiments, the UE is configured or preconfigured, e.g., by a Radio Resource Control, RRC, signaling, with a plurality of different control channel MO skipping patterns and/or numbers of control channel MOs to skip, and, responsive to a certain criterion, the UE is to select which of the configured or preconfigured control channel MO skipping patterns or subset of skipping patterns the UE is to apply.

In accordance with embodiments, the certain criterion comprises one or more of the following:
a battery status of the UE, e.g., a battery charge status is below a configured or preconfigured threshold,
a state of the device,
a channel occupancy or a channel busy ratio, CBR,
a geo location or zone within which the UE is located,
a physical speed of a UE, e.g., a vehicular UE,
whether the UE is located indoors or outdoors,
whether the UE is connected to the wireless communication system directly or via a relay,
a pathloss, like a certain SNR, on a communication link,
a type or capability of the UE,
detecting that no control is transmitted.

In accordance with embodiments, the UE is to skip the control channel MOs responsive to a signaling, the signaling indicating the control channel MO skipping pattern the UE is to apply.

In accordance with embodiments, the signaling, e.g., a Downlink Control Information, DCI, or a Sidelink Control Information, SCI, includes the control channel MO skipping pattern the UE is to apply.

In accordance with embodiments, when the UE is configured or preconfigured, e.g., by an Radio Resource Control, RRC, signaling, with the plurality of different control channel MO skipping patterns and/or the numbers of control channel MOs to skip, the signaling, e.g., a Downlink Control Information, DCI, or a Sidelink Control Information, SCI, includes an indication which of the configured or preconfigured control channel MO skipping patterns the UE is to apply.

In accordance with embodiments, a control channel MO skipping pattern indicates one or more of the following:
a number of control channel MOs to be skipped,
that every n-th control channel MO is to be skipped or not to be skipped, with n=1, 2, 3, . . . ,
a vector or list of MOs that are to be skipped,
a vector or list of MOs that are not to be skipped,
a vector or list of MOs from which n elements are to be skipped,
a vector or list of MOs from which n elements are not to be skipped,
certain search spaces for which the skipping is to be applied,
certain search spaces for which the skipping is not to be applied,
certain DCI or SCI formats that are to be skipped,
certain DCI or SCI formats that are not to be skipped.

The present invention provides a base station, BS, for a wireless communication system, wherein the base station is to serve one or more of the inventive user devices, UEs, and wherein the BS is to configure or preconfigure a UE with the plurality of different control channel MO skipping patterns and/or numbers of control channel MOs to skip.

### Exceptional MOs

The present invention provides a user device, UE, for a wireless communication system, wherein the UE is to skip a certain number of control channel monitoring occasions, MOs, like physical downlink control channel, PDCCH, MOs, or a physical sidelink control channel, PSCCH, MOs, and wherein the UE is to determine one or more exceptional control channel MOs, and the UE is not to skip the one or more exceptional control channel MOs.

In accordance with embodiments, the UE is configured or preconfigured, e.g., by a Radio Resource Control, RRC, signaling, with one or more rules for determining a MO as an exceptional MO, and/or wherein the one or more rules for determining a MO as an exceptional MO are fixed in a specification.

In accordance with embodiments, the one or more rules may include one or more of the following:
the MO is associated with an ongoing transmission or retransmission,
the MO is associated with ongoing periodic transmissions, e.g., SPS,
the MO is associated with a previous transmission of a packet for which a reply is expected,
the MO includes a pre-emption signaling, e.g., when a plurality of transmissions are planned,
the MO includes one or more CSI reports, e.g., for the SL,
the MO uses certain resources for a high priority or emergency signaling,
the MO is associated with pre-reserved transmissions,
the MO contains a common search space.

In accordance with embodiments, the UE is to skip the control channel MOs responsive to a signaling or responsive to a certain criterion.

In accordance with embodiments, the certain criterion comprises one or more of the following:
a battery status of the UE, e.g., a battery charge status is below a configured or preconfigured threshold,
a state of the device,
a channel occupancy or a channel busy ratio, CBR,
a geo location or zone within which the UE is located,
a physical speed of a UE, e.g., a vehicular UE,
whether the UE is located indoors or outdoors,
whether the UE is connected to the wireless communication system directly or via a relay,
a pathloss, like a certain SNR, on a communication link,
a type or capability of the UE,
detecting that no control is transmitted.

In accordance with embodiments, when skipping the k control channel MOs, the UE is
not to count the one or more exceptional control channel MOs so that k control channel MOs are skipped, or
to count the one or more exceptional control channel MOs not skipped so that less than k control channel MOs are skipped.

In accordance with embodiments, the UE is to determine a control channel MO to be an exceptional control channel MO, dependent on a type or format of Downlink Control Information, DCI, or dependent on a type of format of Sidelink Control Information, SCI, associated to a search space that is part of a control channel MO.

In accordance with embodiments, one or more of the following types or formats of DCIs cause a control channel MO to be determined as an exceptional control channel MO:
a DCI including a Downlink Feedback Indicator, DFI,
a DCI including a Slot Format Indicator, SFI,
a DCI including a Preemption Indication or Cancelation Indication,
a DCI including an Availability Indicator,
a wake-up DCI,
a DCI for an activation or deactivation of a ConfiguredGrant, CG,
a DCI for an activation or deactivation of a Semi-Persistent Scheduling, SPS.

In accordance with embodiments, in case the UE is to perform up to K repetitions of a transmission of a Transport Block, TB, the UE is to determine an MO as an exceptional MO if the MO includes a search space associated with a DCI including the DFI so as to allow the UE, responsive to receiving an acknowledgement, ACK, to stop repeating the transmission of the TB before reaching the K repetitions.

In accordance with embodiments, the UE is to skip the exceptional MO with the DCI including the DFI only if a k repetition transmission is currently performed.

In accordance with embodiments, the UE is to determine an MO as an exceptional MO if the MO includes a search space associated with a DCI including a SFI and if one or more of the following conditions are is true:
an uplink, UL, grant or a downlink, DL, assignment of resources is affected by the SFI,
the control channel MO is potentially affected by the SFI,
a configured grant, CG, is potentially affected by the SFI.

In accordance with embodiments, in case of an ongoing communication, like a physical downlink shared channel, PDSCH, reception or a physical uplink shared channel, PUSCH, transmission or a physical sidelink shared channel, PSSCH, reception or transmission, the UE is to determine a certain MO as an exceptional MO if the UE expects to receive a Preemption Indication or a Cancelation Indication in the certain MO.

In accordance with embodiments, one or more of the following types or formats of SCIs cause a control channel MO to be determined as an exceptional control channel MO:
a SCI including a priority field, where the priority is above or below a configured or preconfigured threshold,
a SCI including a Beta offset indicator, where the offset is above or below a configured or preconfigured threshold,
a SCI including a HARQ feedback enabled/disabled indicator.

### Full or Limited Monitoring of Exceptional MOs

In accordance with embodiments, the UE is to monitor in an exceptional MO
all search spaces, or
only the common search spaces, or
only the search spaces or DCI types or SCI types or formats that caused the UE to determine this MO as an exceptional control channel MO.

### Separate PDCCH Skipping Feature for Uu and SL

In accordance with embodiments, the UE is to support a communication with one or more further UEs of the wireless communication network over a sidelink, SL, and wherein the UE is to skip
only SL-related control channel MOs, or
only Uu-related control channel MOs, or
both SL-related control channel MOs and Uu-related control channel MOs.

In accordance with embodiments, the UE is to determine autonomously, using one or more in criteria, to skip the certain number of control channel monitoring occasions, MOs.

### UE Decides to about MO Skipping Autonomously

The present invention provides a user device, UE, for a wireless communication system, wherein the UE is to determine autonomously, using one or more in criteria, to skip a certain number of control channel monitoring occasions, MOs, like physical downlink control channel, PDCCH, MOs, or a physical sidelink control channel, PSCCH.

In accordance with embodiments, the one or more criteria comprises one or more of the following:
a battery status of the UE, e.g., a battery charge status is below a configured or preconfigured threshold,
a state of the device,
a channel occupancy or a channel busy ratio, CBR,
a geo location or zone within which the UE is located,
a physical speed of a UE, e.g., a vehicular UE,
whether the UE is located indoors or outdoors,
whether the UE is connected to the wireless communication system directly or via a relay,
a pathloss, like a certain SNR, on a communication link,
a type or capability of the UE,
detecting that no control is transmitted.

### Separate PDCCH Skipping Feature for Uu and SL—Base Station

The present invention provides a base station, BS, for a wireless communication system, wherein the base station is to serve one or more of the inventive user devices, UEs, wherein the base station is to support a communication of the UEs over the Uu interface and over a sidelink, SL, and wherein the BS is to configure or preconfigure a UE to skip
only SL-related control channel MOs, or
only Uu-related control channel MOs, or
both SL-related control channel MOs and Uu-related control channel MOs.

### General

In accordance with embodiments, for causing the UE to skip the one or more upcoming control channel MOs, the UE is to receive a control message, like a DCI from a base station, indicating to skip the next k PDCCH MOs or PSCCH MOs.

In accordance with embodiments, the UE is configured with one or more default Search Space Groups, SSGs, carrying control information and with one or more empty SSGs, and wherein, for causing the UE to skip the one or more upcoming control channel MOs, the UE is to receive a signaling, e.g., from a base station, to switch to an empty SSG, and, after a certain time period, like an expiry of an inactivity timer, the UE is to switch back to a default SSG.

### System

The present invention provides a wireless communication system, comprising a plurality of the inventive user devices.

### Methods

The present invention provides a method for operating a user device, UE, for a wireless communication system, wherein the UE is to skip a certain number of control channel monitoring occasions, MOs, like physical downlink control channel, PDCCH, MOs, or a physical sidelink control channel, PSCCH, MOs, the method comprising: skipping the certain number of control channel monitoring occasions, MOs, in accordance with a certain control channel MO skipping pattern.

The present invention provides a method for operating a user device, UE, for a wireless communication system, wherein the UE is to skip a certain number of control channel monitoring occasions, MOs, like physical downlink control channel, PDCCH, MOs, or a physical sidelink control channel, PSCCH, MOs, the method comprising: determining one or more exceptional control channel MOs, and not skipping the one or more exceptional control channel MOs.

The present invention provides a method for operating a user device, UE, for a wireless communication system, the method comprising: determining, by the UE, autonomously, using one or more in criteria, to skip a certain number of control channel monitoring occasions, MOs, like physical downlink control channel, PDCCH, MOs, or a physical sidelink control channel, PSCCH.

### Computer Program Product

Embodiments of the present invention provide a computer program product comprising instructions which, when the program is executed by a computer, causes the computer to carry out one or more methods in accordance with the present invention.

### Skipping Patterns

In accordance with embodiments of an aspect of the present invention, rather than simply skipping a certain number of upcoming PDCCH MOs or PSCCH MOs, the UE may apply a certain pattern for the skipping of the MOs. Thus, embodiments, provide a user device or UE that may skip control channel MOs using a certain pattern, responsive to a signaling or a command or an indication, or on its own, e.g., autonomously. For example, the UE is configured or preconfigured, e.g., by a Radio Resource Control, RRC, signaling, with a plurality of different control channel MO skipping patterns and/or with a plurality of different numbers of control channel MOs to skip.

In accordance with embodiments, responsive to a certain criterion, the UE selects autonomously or on its own which of the configured or preconfigured control channel MO skipping patterns or subset of skipping patterns the UE is to apply and/or how many MOs are to be skipped. Thus, the actual pattern to be applied is selected by the UE and is not signaled or elected by another network entity. For example, the one or more criteria may include one or more of the following:
A battery status of the UE.
For example, a battery charge status may be below a configured or preconfigured threshold so that power saving is enabled by applying the control channel MO skipping.
A certain state of the UE.
For example, an IoT device, like a thermostat, may be in summer mode in which it is less likely or happens less often, when compared to a winter mode, that the device receives a request to send temperature data to the network.
A channel occupancy or channel busy ration, CBR.
For example, in delay tolerant applications a device may choose to preserve power by skipping at times when the channel is occupancy is high as using the channel during these times leads to more retransmissions. This especially makes sense for battery powered IoT devices, like a sensor, that are communicating with a relay. As the relay is usually not power limited it will try again after some time if a sensor is currently not responding. Further the relay may also sense channel occupancy and avoid times where the channel busy ratio is too high.
A geo location or zone within which the UE is located.
For example, an operator may pre-configure appropriate skipping configurations for certain areas. This may be due to variances in backhaul quality in these areas or expected congestion at base stations. As increasing the monitoring allows the base station more flexibility it is advantageous for areas with high traffic density. Whereas in areas with little traffic skipping may be effectively applied to preserve power.
The physical speed of a UE.
For example, a vehicular UE may apply the control channel MO skipping. When traveling at a high speed (above a certain configured or preconfigured threshold) it may be needed to receive some control messages form base stations, like RSUs, in the coverage which may be needed to acquire safety related information. While UEs travelling at a lower speed they do not need updates at such a high frequency and hence may skip the control information.
Whether the UE is located indoors or outdoors.
For example, as channel quality indoors may change a lot depending on the position inside the building more frequent adjustment to transmission parameters might be needed and retransmissions or link failure are more likely. In these cases, less skipping can be used to detect this more quickly and give the network time for additional retransmissions.
Whether the UE is connected to a base station, like a gNB, of the wireless communication system directly or via a relay, like a layer-2 relay or a layer-3 relay, or like an IAB node.
For example, when connected to a relay more delay is added to the communication.
To still achieve the same end-to-end latency less skipping may be used. This similarly applies to an IAB node as there is an additional backhaul latency. In these cases, the skipping pattern or k-value may be decreased accordingly or pre-adjusted via one or more configurations that are used depending on the connection.
A pathloss, like a certain SNR, on a communication link.
For example, a communication link between the UE and a base station, like a gNB, via the Uu interface, or between the UE and another UE via the sidelink interface, has a SNR above a configured or preconfigured threshold, so that the number of retransmissions is likely to increase which goes together with an increase in power consumption and which potentially needs the UE to receive more control messages.
A type or capability of the UE, e.g., a pedestrian UE, P-UE, or a vehicular UE.
For example, P-UEs may be needed to receive certain safety-related control messages which is not be skipped.
Detecting that no control is transmitted.
For example, when operating in an unlicensed band, the entity transmitting the control, e.g. gNB, may not be able to acquire the channel and hence may not transmit any control. If the UE detects that the gNB does not transmit it may decide to apply the control channel MO skipping.

In accordance with other embodiments, the UE selects the skipping pattern responsive to a signaling or an indication which indicates the control channel MO skipping pattern the UE is to apply. The signaling provides to the UE the information about the skipping pattern to apply, either explicitly, e.g., by including into the signaling the actual skipping pattern to be used, or implicitly, e.g., by only sending an index or the like to allow the UE to select from configured or preconfigured patterns.

In accordance with further embodiments, the above approaches of determining a skipping pattern to be applied autonomously or responsive to a signalling may both be used by the UE. Thus, in accordance with embodiments, one or more of the following options may be used:
(a) the network, like a BS, decides the skipping pattern to apply,
(b) the UE decides the skipping pattern to apply.

Thus, in accordance with embodiments of the present invention, rather than simply signaling a certain number k of PDCCH MOs or PSCCH MOs that are to be skipped by a UE, a certain pattern for the skipping of the MOs may be applied. For example, rather than skipping every one of the k MOs following the determining that the MO skipping is to be applied, in accordance with embodiments, every n-th MO, like every second, every third, every fourth and so on, MO may be skipped. FIG. 5 illustrates an embodiment of a skipping pattern in accordance with the present invention. FIG. 5 is similar to FIG. 2 and illustrates a plurality of time slots or frames including respective control message MOs, like PDCCH MOs or PSCCH MOs. It is assumed that a UE receives in time slot 2 the skipping signaling 200. In accordance with embodiments of the present invention, the UE, responsive to the skipping indication 200 applies a skipping feature, and FIG. 5 illustrates a skipping feature in which every second MO is skipped. Thus, responsive to receiving the signaling 200 in time slot 2, the MOs in time slots 4, 6, 8 and so on are skipped. The skipping signaling 200 may include an indication of the number of MOs to be skipped, like k MOs. In accordance with embodiments, only the actually skipped MOs are counted, so that, in total, the k MOs as signaled by the skipping signaling 200 are skipped. In accordance with other embodiments, all MOs following the skipping signaling 200 may be counted, so that when applying the skipping pattern skipping only every n-th MO, this is applied only to the k MOs following time slot 2 so that in the embodiment of FIG. 5, since only every second MO is skipped, the overall number of actually skipped MOs is less than k, in the embodiment depicted in FIG. 5 it is k/2, i.e., only half of the MOs signaled to be skipped are actually skipped when applying the skipping pattern.

In accordance with other embodiments of the present invention, the skipping pattern may indicate the actual MOs to be skipped, for example, the signaling 200 may signal to the UE to apply a skipping pattern that indicates those MOs to be skipped and those not to be skipped. For example, the skipping pattern may define one or more of the following:
a number of control channel MOs to be skipped, e.g., how many of the MOs are to be skipped,
a vector or list of MOs that are to be skipped,
a vector or list of MOs that are not to be skipped,
a vector or list of MOs from which n elements are to be skipped, for example, by signaling a pattern m to be used for skipping and a number n of how many MOs should be skipped using the pattern m,
a vector or list of MOs from which n elements are not to be skipped,
certain search spaces for which the skipping is to be applied,
certain search spaces for which the skipping is not to be applied,
certain DCI or SCI formats that are to be skipped,
certain DCI or SCI formats that are not to be skipped.

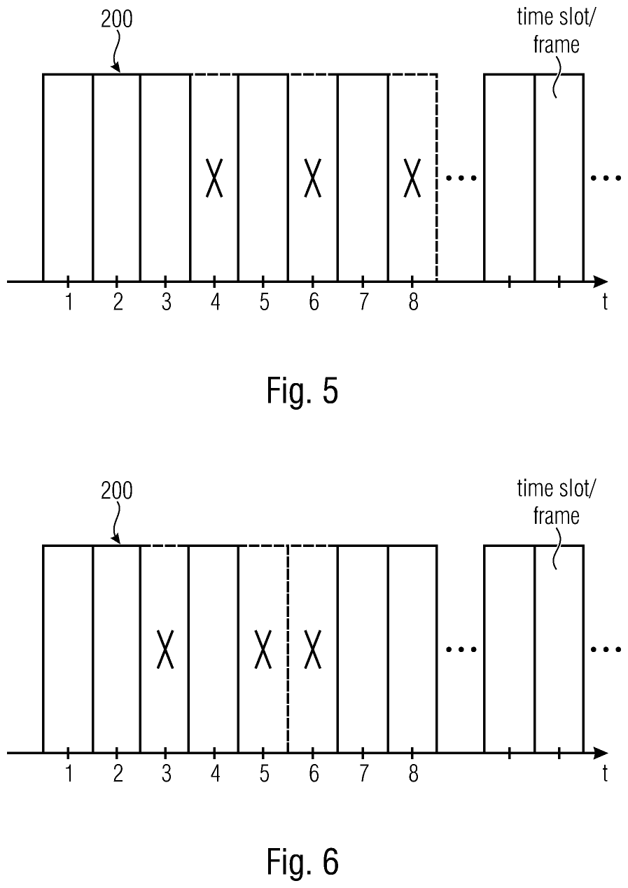

FIG. 6 illustrates an embodiment of the present invention in accordance with which, responsive to the skipping signaling 200, the UE is to apply a skipping pattern which indicates that the MOs at time slots 3, 5, 6 are to be skipped, while the MOs at time slots 4, 7 and 8 are not to be skipped. For example, time slots 4, 7 and 8 may include certain search spaces or carry certain DCI/SCI formats that are considered important for a correct and reliable operation of the UE so that these MOs are not to be skipped. On the other hand, the MOs in time slots 3, 5 and 6 are considered to include search spaces or control message formats which are not important or essential for a correct operation of the UE so that these MOs may be skipped.

With regard to FIG. 5 and FIG. 6 it is noted that the inventive approach is not limited to the depicted embodiments, rather, when considering FIG. 5, also every third or every fourth MO may be skipped, and with regard to FIG. 6, also more or less or other MOs may be skipped or not skipped.

In accordance with embodiments, the skipping signaling 200 may include the actual skipping pattern to be applied by a receiving UE, while in accordance with other embodiments, the UE may be configured or preconfigured, for example by an RRC signaling, with one or more skipping patterns to be used. Responsive to the skipping signaling 200, in case only a single skipping pattern is configured or preconfigured in the UE, the UE applies the skipping pattern. In case two or more skipping patterns are configured or preconfigured in the UE, the skipping signaling 200 may include an indication which of the configured or preconfigured skipping patterns in the UE is to be applied.

### Exceptional Monitoring Occasions

In accordance with embodiments of a further aspect of the present invention, rather than using a fixed skipping pattern as described in the embodiments above, the UE may determine certain monitoring occasions, MOs, that may include control information or control messages that may be critical or essential for operating the UE in certain situations, and such control channel MOs are also referred to in the following as exceptional MOs. The exceptional MOs are not affected by the skipping, e.g., responsive to receiving the signaling 200, the UE may exclude those MOs it determined to be exceptional from the skipping.

In accordance with embodiments, the UE is configured or preconfigured, e.g., by a Radio Resource Control, RRC, signaling, with one or more rules for determining a MO as an exceptional MO, and/or the one or more rules for determining a MO as an exceptional MO are fixed in a specification. The rules may include one or more of the following:
the MO is associated with an ongoing transmission or retransmission,
the MO is associated with ongoing periodic transmissions, e.g., SPS,
the MO is associated with a previous transmission of a packet for which a reply is expected,
the MO includes a pre-emption signaling, e.g., when a plurality of transmissions are planned,
the MO includes one or more CSI reports, e.g., for the SL,
the MO uses certain resources for a high priority or emergency signaling,
the MO is associated with pre-reserved transmissions,
the MO includes a common search space, like a common search space monitored by multiple UEs.

In accordance with further embodiments, the UE may decide about applying the skipping and non-skipping of control channel MOs responsive to a signaling or, on its own using, for examples, one or more of the criteria described above for selecting autonomously or on its own a control channel MO skipping pattern.

In accordance with embodiments, the UE may not count the exceptional MOs such that when determining, for example, the k PDCCH MOs to be skipped, in total k MOs are skipped by the UE. In accordance with other embodiments, the exceptional MOs may also be taken into consideration for determining the overall number of MOs to be skipped, so that when applying this approach, the UE considers the next k MOs but does not apply the skipping to those MOs identified to be exceptional. Thus, in case the UE determines n exceptional MOs, with n=1, 2, 3, . . . , responsive to a signaling 200 indicating k MOs to be skipped, the UE actually skips only k-n MOs.

In accordance with embodiments, an exceptional MO may be determined dependent on a type or format of the control message being associated with the monitoring occasion, like a DCI or SCI being associated with a search space is part of the PDCCH MO or PSSCH MO.

In accordance with embodiments, when determining at a certain monitoring occasion one or more of the following DCI types or formats, the MO may be regarded by the UE as an exceptional MO:
a DCI including the downlink feedback indicator, DFI,
a DCI including the slot format indicator, SFI,
a DCI including an indication of a preemption or a cancellation,
a DCI including an availability indicator
a wake-up DCI, like a DCI including a wake-up signal, WUS,
a DCI for the activation or deactivation of a configured grant, CG,
a DCI for the activation or deactivation of a semi-persistent scheduling, SPS.

In accordance with further embodiments, when determining at a certain monitoring occasion one or more of the following SCI types or formats, the MO may be regarded by the UE as an exceptional MO:
a SCI including a priority field, where the priority is above or below a configured or preconfigured threshold,
a SCI including a Beta offset indicator, where the offset is above or below a configured or preconfigured threshold,
a SCI including a HARQ feedback enabled/disabled indicator.

In accordance with embodiments, the MOs illustrated in FIG. 5 and FIG. 6 to be skipped, namely the MOs at time slots 4, 6, 8 in FIG. 5 or the MOs at time slots 3, 5, 6 in FIG. 6 may be selected, other than described above with reference to FIG. 5 and FIG. 6, when the UE determines these MOs to include critical control information, like Cis or SCIs having the above-mentioned types or formats. Naturally, any other pattern of skipped or omitted MOs is possible, dependent on whether a certain MO following the signaling 200 is considered by the UE as an exceptional MO.

### Downlink Feedback Indicator

A MO may be regarded as an exceptional MO by the UE in case a DCI associated with the MO includes the DFI, which may be employed by the UE when performing up to K repetitions of the transmission of a transport block TB, also referred to as the UL K-repetition feature. While performing the up to K, K=1, 2, 3, . . . , repetitions of the TB, the UE, in parallel, monitors the PDCCH for a DCI including the DFI field. The DFI field may indicate an acknowledgement, ACK, for the current one of the up to K repetitions of the TB which, in turn, causes the UE to stop repeating the transmission earlier, i.e., before actually reaching the K repetitions. However, in case the UE receives the PDCCH skipping signal 200, it may also skip the monitoring of the control message for the DFI so that, in such a situation, despite the fact that some energy saving is achieved by not monitoring all PDCCH monitoring occasions, still all the K repetitions of the transmission of the TB are performed by the UE. However, this leads to an unnecessary consumption of energy because the repetition or retransmission of the TB is not needed as it was already successfully received at the base station as acknowledged by the DFI which, however, has not been received at the UE.

Therefore, in accordance with embodiments, a MO associated with the DCI including the DFI is considered an exceptional MO that is still monitored by the UE when it performs the above-described uplink K-repetition transmission of the TB. Upon checking the specific DCI format, the UE can tell whether the DCI leads to a situation in which the MO carrying the DCI is to be considered an exceptional MO which, despite the skipping instruction 200, is monitored by the UE. In accordance with embodiments, other DCI formats, more specifically other monitoring occasions associated with other DCI formats, may be skipped in accordance with the skipping signaling 200, thereby causing the UE to monitor only a reduced set of monitoring occasions or search spaces, namely those including the DCI format having the DFI. This ensures that, in addition to the power saving by skipping multiple PDCCH monitoring occasions, also an energy consumption is reduced because unnecessary retransmissions concerning an uplink transmission from the UE towards the base station, is avoided in case the acknowledgment of the receipt of the initial transmission or a later retransmission is received.

### DCI Including the SFI

In accordance with other embodiments, as mentioned above, the UE may continue to monitor PDCCH monitoring occasions associated with the DCI format including the SFI field. For example, in TDD systems, the SFI field indicates whether certain slots or symbols in a slot are to be considered as downlink, DL, or uplink, UL, slot/symbol. Dependent on the signaling, certain MOs may be present or not, which may affect the counting of the skipped MOs. Also, configured grants, CGs, may be used or not used dependent on whether a certain number of slots or symbols are declared to be UL or DL slots/symbols. Thus, for properly operating the UE, it is to monitor the PDCCH monitoring occasions for DCI formats including the SFI, despite the receipt of the skipping signaling 200. For example, the monitoring of MOs associated with DCI formats including the SFI may be tied to one or more of the following conditions:
an uplink, UL, grant or a downlink, DL, assignment of resources is affected by the SFI,
the control channel MO is potentially affected by the SFI,
a configured grant, CG, is potentially affected by the SFI.

In accordance with such embodiments, the UE may only monitor a monitoring occasion associated with a DCI format including the SFI if at least one of the above-mentioned conditions is met or is true, i.e. in case the SFI has some influence or effect on any one of the mentioned procedures, namely the uplink grant, the downlink assignment, the monitoring occasions, the configured grant or the SPS.

In case a monitoring occasion associated with the DCI format including the SFI is skipped, the symbols indicated by the SFI to be downlink or uplink symbols, need to be treated as flexible until the next monitoring occasion associated with a DCI format including the SFI. Hence, these symbols may not be used, e.g., for Configured Grants. Furthermore, the gNB may want to overwrite a previous SFI due to a change in the cell environment or the channel which is not possible once the UE is indicated to skip these MOs.

### Preemption Indication/Cancelation Indication

In accordance with embodiments, a UE may support a preemption indication or cancelation indication indicating that certain resources are no longer available, e.g., resources for a PDSCH reception or PUSCH transmission over the Uu interface, or for or a physical sidelink shared channel, PSSCH, reception/transmission. However, in case the UE is to skip PDCCH MOs associated with a DCI including the preemption indication or cancelation indication, the actual occurrence of a preemption or cancelation can no longer be handled by the UE.

Therefore, in accordance with embodiments of the present invention, in case the UE has a PDSCH reception or a PUSCH transmission before or during the time period over which the PDCCH MOs are to be skipped in accordance with the signaling 200, the UE does not skip those PDCCH MOs in which expects to receive a preemption indication or cancelation indication, thereby maintaining the proper operation of the UE.

### Full or Limited Monitoring of the Exceptional MOs

In accordance with further embodiments of the present invention, when considering the above-described exceptional monitoring occasions, UE monitors in an exceptional MO exceptional MO
all search spaces, or
common search spaces only, or
only the search spaces or DCI/SCI types/formats that caused the UE to determine this MO as an exceptional control channel MO.

Thus, the UE may apply either a full monitoring or a limited monitoring of the search spaces associated with the exceptional MOs or only common search spaces. The UE may be configured or preconfigured to use one of the three approaches. The UE may monitor one or more CORESETs including the search spaces carrying control messages for the UE, and when applying the full monitoring, the UE may monitor all search spaces within the one or more CORESETs that are associated with the exceptional MO. In accordance with embodiments applying the limited monitoring, the UE monitors only the search spaces within the one or more CORESETs that are associated with the exceptional MO. Thus, the limited monitoring further reduces the power consumption as, other than in the full monitoring case, not all search spaces are to be monitored, but only those associated, for example, with the DCI format on the basis of which the UE determined the search space to be an exceptional MO.

UE Autonomously Deciding about Control Channel MO Skipping

In the embodiments described so far, it is assumed that the UE received some signaling causing the UE to perform the conventional control channel MO skipping and to apply the inventive improvements. Stated differently, a UE is, conventionally, put into a control channel MO skipping mode by another network entity, like a base station. However, as mentioned above, there may be situations in which the UE is to save power but may not receive any control signaling from the base station, or the wireless communication network may not be aware of a certain situation at the UE the needs the power saving. For example, a UE communicating over the sidelink or using an unlicensed band may not receive a control signaling from the base station. Further, when considering a UE, like an IOT device for smart metering applications, communicating with the base station over the Uu interface, the base station may not be aware that IoT device has very low battery status so that power saving is needed at the IoT device.

These problems are addressed in accordance with embodiments of a yet further aspect of the present invention by allowing a UE to decide on its own or autonomously to apply control channel MO skipping. The UE may be configured or preconfigured with certain situation and/or rules in which it may apply MO skipping autonomously or independent of any signaling from the system. Thus, instead of relying on a signaling or indication from another network entity, the UE may decide on its own whether to enter into the control channel MO skipping mode for saving power.

Embodiments of the present invention provide a user device or UE that, using one or more in criteria, determines autonomously to skip a certain number of control channel monitoring occasions, MOs, like physical downlink control channel, PDCCH, MOs, or a physical sidelink control channel, PSCCH. For example, the one or more criteria may include one or more of the following:
A battery status of the UE.
For example, a battery charge status may be below a configured or preconfigured threshold so that power saving is enabled by applying the control channel MO skipping.
A certain state of the UE.
For example, an IoT device, like a thermostat, may be in summer mode in which it is less likely or happens less often, when compared to a winter mode, that the device receives a request to send temperature data to the network.
A channel occupancy or channel busy ration, CBR.
For example, in delay tolerant applications a device may choose to preserve power by skipping at times when the channel is occupancy is high as using the channel during these times leads to more retransmissions. This especially makes sense for battery powered IoT devices, like a sensor, that are communicating with a relay. As the relay is usually not power limited it will try again after some time if a sensor is currently not responding. Further the relay may also sense channel occupancy and avoid times where the channel busy ratio is too high.
A geo location or zone within which the UE is located.
For example, an operator may pre-configure appropriate skipping configurations for certain areas. This may be due to variances in backhaul quality in these areas or expected congestion at base stations. As increasing the monitoring allows the base station more flexibility it is advantageous for areas with high traffic density. Whereas in areas with little traffic skipping may be effectively applied to preserve power.
The physical speed of a UE.
For example, a vehicular UE may apply the control channel MO skipping. When traveling at a high speed (above a certain configured or preconfigured threshold) so as it may be needed to receive some control messages form base stations, like RSUs, in the coverage which may be needed to acquire safety related information. While UEs travelling at a lower speed they do not need updates at such a high frequency and hence can may skip the control information.
Whether the UE is located indoors or outdoors.
For example, as channel quality indoors may change a lot depending on the position inside the building more frequent adjustment to transmission parameters might be needed and retransmissions or link failure are more likely. In these cases, less skipping can be used to detect this more quickly and give the network time for additional retransmissions.
Whether the UE is connected to a base station, like a gNB, of the wireless communication system directly or via a relay, like a layer-2 relay or a layer-3 relay, or like an IAB node.
For example, when connected to a relay more delay is added to the communication. To still achieve the same end-to-end latency less skipping may be used. This similarly applies to an IAB node as there is an additional backhaul latency. In these cases, the skipping pattern or k-value may be decreased accordingly or pre-adjusted via one or more configurations that are used depending on the connection.
A pathloss, like a certain SNR, on a communication link.
For example, a communication link between the UE and a base station, like a gNB, via the Uu interface, or between the UE and another UE via the sidelink interface, has a SNR above a configured or preconfigured threshold, so that the number of retransmissions is likely to increase which goes together with an increase in power consumption and which potentially needs the UE to receive more control messages.
A type or capability of the UE, e.g., a pedestrian UE, P-UE, or a vehicular UE.
Detecting that no control is transmitted.
For example, when operating in an unlicensed band, the entity transmitting the control, e.g. gNB, may not be able to acquire the channel and hence may not transmit any control. If the UE detects that the gNB does not transmit it may decide to apply the control channel MO skipping.

In accordance with further embodiments, once the UE decided to apply control channel MO skipping, it may do so in accordance with conventional approaches, namely simply skipping the next k upcoming control channel MOs. In such cases, the UE may be configured or preconfigured with the number k of control channel MOs to skip. Further, in accordance with embodiments, the UE may apply any of the above described embodiments for determining which of the upcoming control channel MOs are to be skipped, e.g., in accordance with the inventive skipping pattern or by not skipping MOs determined to be exceptional.

### Control Message Skipping for Uu and SL

The embodiments of the aspects of the present invention were described primarily with reference to the Uu interface for connecting a UE to the access point of a RAN, like a base station. However, the inventive approach may equally be applied to a sidelink communication. Thus, also UEs communicating only with each other over the sidelink and, e.g., are not supported with regard to the resource allocation by the base station of the network, may also employ the inventive approaches for further power savings when applying the control message skipping feature, while avoiding undesired drawbacks or malfunctions of the UEs due to missed control messages.

In accordance with embodiments, when the UEs provides for a connection to both the base station and to another UE, the skipping feature may be applied separately for the Uu related PDCCH MOs and the SL-related PDCCH MOs so that, for example, power savings are possible in one of the connections, like in the Uu connection, without affecting the other communication link, like the SL link or the other way around. For example, the UE may be configured accordingly by a base station.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

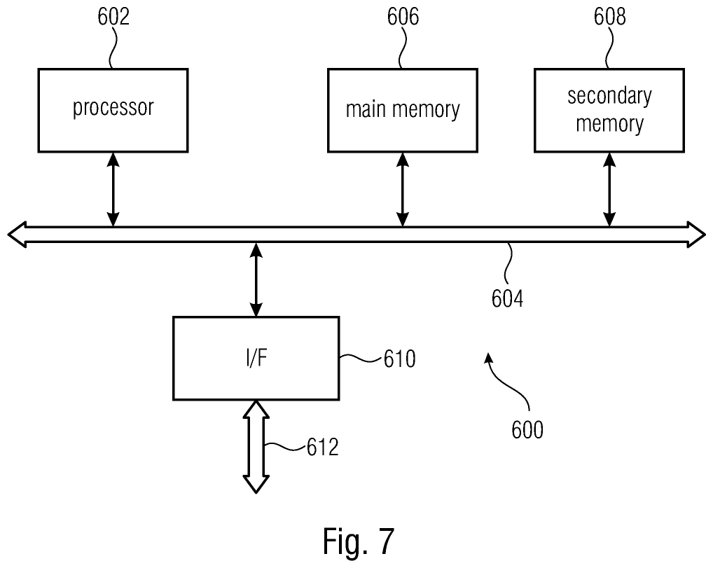

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 7 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A user device, UE, for a wireless communication system,
wherein the UE is to skip a certain number of control channel monitoring occasions, MOs, like physical downlink control channel, PDCCH, MOs, or a physical sidelink control channel, PSCCH, MOs,
wherein, among the channel monitoring occasions to be skipped, the UE is to determine one or more exceptional control channel MOs which are not to be skipped, and the UE is not to skip the one or more exceptional control channel MOs,
wherein the UE is configured or preconfigured, e.g., by a Radio Resource Control, RRC, signaling, with one or more rules for determining a MO as an exceptional MO, and/or wherein the one or more rules for determining a MO as an exceptional MO are fixed in a specification, and
wherein the one or more rules may comprise one or more of the following:
the MO is associated with an ongoing transmission or retransmission,
the MO is associated with ongoing periodic transmissions, e.g., SPS,
the MO is associated with a previous transmission of a packet for which a reply is expected,
the MO comprises a pre-emption signaling, e.g., when a plurality of transmissions are planned,
the MO comprises one or more CSI reports, e.g., for the SL,
the MO uses certain resources for a high priority or emergency signaling,
the MO is associated with pre-reserved transmissions,
the MO comprises a common search space.

2. The user device, UE, of claim 1, wherein the UE is to skip the control channel MOs responsive to a signaling or responsive to a certain criterion.

3. The user device, UE, of claim 2, wherein the certain criterion comprises one or more of the following:
a battery status of the UE, e.g., a battery charge status is below a configured or preconfigured threshold,
a state of the device,
a channel occupancy or a channel busy ratio, CBR,
a geo location or zone within which the UE is located,
a physical speed of a UE, e.g., a vehicular UE,
whether the UE is located indoors or outdoors,
whether the UE is connected to the wireless communication system directly or via a relay,
a pathloss, like a certain SNR, on a communication link,
a type or capability of the UE,
detecting that no control is transmitted.

4. The user device, UE, of claim 1, wherein, when skipping the k control channel MOs, the UE is
not to count the one or more exceptional control channel MOs so that k control channel MOs are skipped, or
to count the one or more exceptional control channel MOs not skipped so that less than k control channel MOs are skipped.

5. The user device, UE, of claim 1, wherein the UE is to determine a control channel MO to be an exceptional control channel MO, dependent on a type or format of Downlink Control Information, DCI, or dependent on a type of format of Sidelink Control Information, SCI, associated to a search space that is part of a control channel MO.

6. The user device, UE, of claim 5, wherein one or more of the following types or formats of DCIs cause a control channel MO to be determined as an exceptional control channel MO:
a DCI comprising a Downlink Feedback Indicator, DFI,
a DCI comprising a Slot Format Indicator, SFI,
a DCI comprising a Preemption Indication or Cancelation Indication,
a DCI comprising an Availability Indicator,
a wake-up DCI,
a DCI for an activation or deactivation of a ConfiguredGrant, CG,
a DCI for an activation or deactivation of a Semi-Persistent Scheduling, SPS.

7. The user device, UE, of claim 6, wherein, in case the UE is to perform up to K repetitions of a transmission of a Transport Block, TB, the UE is to determine an MO as an exceptional MO if the MO comprises a search space associated with a DCI comprising the DFI so as to allow the UE, responsive to receiving an acknowledgement, ACK, to stop repeating the transmission of the TB before reaching the K repetitions.

8. The user device, UE, of claim 7, wherein the UE is to skip the exceptional MO with the DCI comprising the DFI only if a k repetition transmission is currently performed.

9. The user device, UE, of claim 6, wherein the UE is to determine an MO as an exceptional MO if the MO comprises a search space associated with a DCI comprising a SFI and if one or more of the following conditions are is true:
an uplink, UL, grant or a downlink, DL, assignment of resources is affected by the SFI,
the control channel MO is potentially affected by the SFI,
a configured grant, CG, is potentially affected by the SFI.

10. The user device, UE, of claim 6, wherein, in case of an ongoing communication, like a physical downlink shared channel, PDSCH, reception or a physical uplink shared channel, PUSCH, transmission or a physical sidelink shared channel, PSSCH, reception or transmission, the UE is to determine a certain MO as an exceptional MO if the UE expects to receive a Preemption Indication or a Cancelation Indication in the certain MO.

11. The user device, UE, of claim 5, wherein one or more of the following types or formats of SCIs cause a control channel MO to be determined as an exceptional control channel MO:
a SCI comprising a priority field, where the priority is above or below a configured or preconfigured threshold,
a SCI comprising a Beta offset indicator, where the offset is above or below a configured or preconfigured threshold,
a SCI comprising a HARQ feedback enabled/disabled indicator.

12. The user device, UE, of claim 1, wherein the UE is to monitor in an exceptional MO
all search spaces, or
only the common search spaces, or
only the search spaces or DCI types or SCI types or formats that caused the UE to determine this MO as an exceptional control channel MO.

13. The user device, UE, of claim 1, wherein the UE is to support a communication with one or more further UEs of the wireless communication network over a sidelink, SL, and
wherein the UE is to skip
only SL-related control channel MOs, or
only Uu-related control channel MOs, or
both SL-related control channel MOs and Uu-related control channel MOs.

14. The user device, UE, of claim 1, wherein, for causing the UE to skip the one or more upcoming control channel MOs, the UE is to receive a control message, like a DCI from a base station, indicating to skip the next k PDCCH MOs or PSCCH MOs.

15. The user device, UE, of claim 1, wherein the UE is configured with one or more default Search Space Groups, SSGs, carrying control information and with one or more empty SSGs, and
wherein, for causing the UE to skip the one or more upcoming control channel MOs, the UE is to receive a signaling, e.g., from a base station, to switch to an empty SSG, and, after a certain time period, like an expiry of an inactivity timer, the UE is to switch back to a default SSG.

16. The user device, UE, of claim 1, wherein the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a vehicular UE, or a vehicular group leader (GL) UE, or an IoT or narrowband IoT, NB-IoT, device, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

17. A wireless communication system, comprising
one or more user devices, UEs, of claim 1, and
a base station for serving the one or more, UEs,
wherein the base station is to support a communication of the UEs over the Uu interface and over a sidelink, SL, and
wherein the BS is to configure or preconfigure a UE to skip
only SL-related control channel MOs, or
only Uu-related control channel MOs, or
both SL-related control channel MOs and Uu-related control channel MOs.

18. A method for operating a user device, UE, for a wireless communication system, wherein the UE is to skip a certain number of control channel monitoring occasions, MOs, like physical downlink control channel, PDCCH, MOs, or a physical sidelink control channel, PSCCH, MOs, the method comprising:
determining which are not to be skipped one or more exceptional control channel MOs which are not to be skipped, and
not skipping the one or more exceptional control channel MOs,
wherein the UE is configured or preconfigured, e.g., by a Radio Resource Control, RRC, signaling, with one or more rules for determining a MO as an exceptional MO, and/or wherein the one or more rules for determining a MO as an exceptional MO are fixed in a specification, and
wherein the one or more rules may include one or more of the following:
the MO is associated with an ongoing transmission or retransmission,
the MO is associated with ongoing periodic transmissions, e.g., SPS,
the MO is associated with a previous transmission of a packet for which a reply is expected,
the MO comprises a pre-emption signaling, e.g., when a plurality of transmissions are planned,
the MO comprises one or more CSI reports, e.g., for the SL,
the MO uses certain resources for a high priority or emergency signaling,
the MO is associated with pre-reserved transmissions,
the MO comprises a common search space.
